(19) United States
(12) Patent Application Publication
(10) Pub. No.: US 2019/0091690 A1
(43) Pub. Date: Mar. 28, 2019

(54) METHOD AND APPARATUS OF GENERATING SUBSTANTIALLY MONODISPERSE DROPLETS

(71) Applicant: Tantti Laboratory Inc., Taoyuan City (TW)

(72) Inventors: Hui CHEN, Taoyuan City (TW); Pang LIN, Taoyuan City (TW); Bo-Han HUANG, Taoyuan City (TW); Chun-Kai WANG, Taoyuan City (TW)

(21) Appl. No.: 15/713,822

(22) Filed: Sep. 25, 2017

(51) Int. Cl. B01L 3/00

(52) U.S. Cl. CPC B01L 3/502784

(57) ABSTRACT

The invention relates to a method and an apparatus for generating substantially monodisperse droplets. The invention involves flowing a continuous phase fluid in a microfluidic passageway which extends along a longitudinal length direction and has a substantially constant cross section along the length direction. A dispersed phase fluid is introduced into the microfluidic passageway along a traverse direction through inlet orifices to generate droplets of the dispersed phase fluid in the continuous phase fluid. The inlet orifices have a substantially uniform diameter, and any adjacent two of the inlet orifices are arranged to be offset from each other in the length direction. The dispersed phase fluid is broken up by the shear stress generated by the continuous phase fluid to produce monodisperse droplets. By the offsetting arrangement of the inlet orifices, droplets formed by adjacent inlet orifices will not interfere with each other, thereby ensuring the uniformity of the droplets.

### BACKGROUND OF INVENTION

### 1. Field of the Invention

The present invention relates to a method and an apparatus for generating a large amount of monodisperse droplets.

### 2. Description of Related Art

In the past 20 years, miniaturized devices have become important in biological and chemical applications, and the development of “microfluidics” technology has been particularly attracting attention. Microfluidics is a new interdisciplinary technology developed on the basis of microelectronics, micro-fabrication, bioengineering and nanotechnology, which utilizes microfluidic passageways in microfluidic devices (5 to 500 μm in channel diameter) to manipulate, operate and control trace amounts of liquids or samples on a microscopic scale. The microfluidic device is typically configured as a microfluidic chip integrating microfluidic channel networks with various functional units, enabling a controllable implementation of sample preparation, reaction, separation and detection in a single device. Early studies focused on the manipulation of continuous flow systems in microfluidic channels, including the feeding, mixing, reaction, separation and detection processes. However, traditional continuous flow systems exhibit certain limitations, such as high sample consumption, high sophistication and low manufacturing effectiveness of micro-pumps and micro-valves, the tendency of cross-contamination and the difficulty in rapid mixing between flows under a low Reynolds number.

In recent years, there has been a new branch in the technical field of microfluidics—discontinuous flow microfluidic system, also known as microfluidic droplet system. The microfluidic droplet system employs two immiscible fluids to form droplets at the interface in a microfluidic channel. Compared with the continuous flow system, the microfluidic droplet system has advantages of forming droplets with small volumes, low diffusion, no cross-contamination, and rapid reaction kinetics, and has the potential of high throughput analysis. Because of these potential advantages, the microfluidic droplet technology has been gaining much attention from researchers. And after several years of development, the droplet preparation has become increasingly mature, so that it has been applied to chemical and biochemical analysis and many other technical fields.

Microfluidic droplet technology involves droplet generation and droplet driving, and the droplet manipulation may be divided into two categories in terms of the droplet generation processes. One category is directed to passive methods, which manipulate the droplets by flowing fluids through a specially designed microfluidic passageway that generates a local flow velocity gradient and mainly involves a multiphase flow processing. The methods of this type have an advantage of rapidly producing batches of droplets. The other one relates to the so-called active methods, in which droplets are generated by applying an electric field, thermal energy or other external forces to a flow to generate a local energy gradient. The methods include electrowetting processes, dielectrophoresis processes, pneumatic processes and thermal capillary processes, and are characterized in the capability of manipulating individual droplets.

As described above, the multiphase flow processing involves unique designs on the microfluidic channel configuration and the manipulation of the flow rates of fluids. By virtue of the interaction between the fluids governed by factors such as shear stress, viscosity of fluids and surface tension, a velocity gradient is generated locally in a dispersed phase fluid within the microfluidic passageway, so that the dispersed phase fluid is broken up into discrete droplets evenly distributed in a immiscible continuous phase to form a monodisperse system. The multiphase flow processing advantageously realizes an easy manipulation on individual batches of droplets. In the review article by G. F. Christopher and S. L. Anna (G F. Christopher and S. L. Anna, Microfluidic methods for generating continuous droplet streams, J. Phys. D: Appl. Phys. 40 (2007), R319-R336), three major approaches to prepare droplets were described: T-junction, flow-focusing and co-axial flow. The microfluidic passageways are designed differently in these approaches. The factors that may affect the preparation of droplets include the material of the microfluidic passageway, the geometry and size of the microfluidic passageway, the properties of the fluids (e.g., viscosity and surface tension), and flow rate ratio.

The development prospect of microfluidic droplet technology has attracted much attention and remarkable progress has been made in relevant studies. However, there is still an eager need in the related technical field for a simple process to rapidly produce large quantities of droplets in uniform size.

### SUMMARY OF THE INVENTION

In view of the above, a primary object of the invention is to provide a method and an apparatus for producing a large amount of monodisperse droplets.

In the first aspect provided herein is a method of generating substantially monodisperse droplets. Said method comprises the steps of:

flowing a continuous phase fluid in a microfluidic passageway which extends in a longitudinal length direction, wherein the microfluidic passageway has a substantially constant cross section throughout its length; and

introducing a dispersed phase fluid into the microfluidic passageway along a traverse direction to the length direction through a plurality of inlet orifices to generate droplets of the dispersed phase fluid in the continuous phase fluid, wherein the plurality of inlet orifices have a substantially uniform diameter, and wherein any adjacent two of the plurality of inlet orifices are arranged offset from each other in the length direction.

In one preferred embodiment, the step of introducing the dispersed phase fluid along the traverse direction comprises introducing the dispersed phase fluid at an angle of about 90 degrees relative to the length direction.

In the second aspect provided herein is an apparatus of generating substantially monodisperse droplets. The apparatus comprises a substantially rigid first part, and a substantially rigid second part arranged opposite to the first part to define a microfluidic passageway there-between through which a continuous phase fluid may flow, wherein the microfluidic passageway extends in a longitudinal length direction and has a substantially constant cross section throughout its length. The apparatus is further formed with a plurality of inlet orifices through which a dispersed phase fluid may be introduced into the microfluidic passageway along a traverse direction to the length direction to generate droplets of the dispersed phase fluid in the continuous phase fluid, and wherein the plurality of inlet orifices have a substantially uniform diameter, and wherein any adjacent two of the plurality of inlet orifices are arranged offset from each other in the length direction.

According to the invention, the dispersed phase fluid is introduced into the continuous phase fluid through the plurality of inlet orifices. The continuous phase fluid is confined in the microfluidic passageway having an extremely narrow annular configuration and forced to flow rapidly along the longitudinal length direction, so that the dispersed phase fluid is broken up by the shear stress generated by the continuous phase fluid to produce a large quantity of monodisperse droplets with substantially equal size. By virtue of the technical feature that the adjacent inlet orifices are arranged offset from each other in the length direction, preferably the inlet orifices being spaced apart from one another by a substantially equal distance, the droplets formed by the adjacent inlet orifices will not interfere with each other, thereby ensuring the quality of the droplets while the uniformity of these droplets can be assured by the unique configuration and arrangement of the microfluidic passageway and the inlet orifices.

In a preferred embodiment, the first part is configured in the form of a rod extending in the length direction, and the second part is configured in the form of an outer tubular housing concentrically disposed about the rod, thereby defining the microfluidic passageway in an annular configuration. The first part and the second part may be optionally configured to be with a cross section having a circular, square, hexagonal or other geometric shape.

In a preferred embodiment, the inlet orifices are formed on the first part or the second part. When the inlet orifices are formed on the first part, the first part is configured in the form of a hollow rod extending in the length direction.

In a preferred embodiment, the first part includes a first end provided with a first anchoring member which is secured to a first end of the second part, thereby preventing the first part from dislocating relative to the second part.

In a preferred embodiment, the first part includes a second end opposite to the first end of the first part, the second end of the first part being provided with a second anchoring member which radially abuts against a second end of the second part opposite to the first end of the second part, thereby preventing the first part from deviating radially with respect to the second part.

In a preferred embodiment, the first anchoring member is formed with an inlet for the continuous phase fluid, and wherein the first end of the first part is tapered toward the inlet in the length direction, thereby defining with the first end of the second part a first connecting channel connecting in fluid communication the inlet to the microfluidic passageway.

In a preferred embodiment, the second anchoring member is formed with an outlet, and wherein the second end of the first part is tapered toward the outlet in the length direction, thereby defining with the second end of the second part a second connecting channel connecting in fluid communication the outlet to the microfluidic passageway.

In a preferred embodiment, the plurality of inlet orifices are arranged such that the dispersed phase fluid may be introduced into the microfluidic passageway at an angle of about 90 degrees relative to the length direction.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic diagram showing the apparatus according to the first preferred embodiment of the invention;

FIG. 2 is a schematic diagram showing the inlet orifices according to the first preferred embodiment of the invention;

FIG. 3 is a schematic diagram showing the formation of monodisperse droplets according to the invention;

FIG. 4 is a schematic diagram showing the inlet orifices according to the second preferred embodiment of the invention;

FIG. 5 is a schematic diagram showing the inlet orifices according to the third preferred embodiment of the invention;

FIG. 6 is a schematic diagram showing the apparatus according to the second preferred embodiment of the invention;

FIG. 7 is a perspective view of the apparatus according to the second preferred embodiment of the invention; and

FIG. 8 is a schematic diagram showing the apparatus according to the third preferred embodiment of the invention.

### DETAILED DESCRIPTION OF THE INVENTION

Unless specified otherwise, the following terms as used in the specification and appended claims are given the following definitions. It should be noted that the indefinite article “a” or “an” as used in the specification and claims is intended to mean one or more than one, such as “at least one,” “at least two,” or “at least three,” and does not merely refer to a singular one. In addition, the terms “comprising/comprises,” “including/includes” and “having/has” as used in the claims are open languages and do not exclude unrecited elements. The term “or” generally covers “and/or”, unless otherwise specified. The terms “about” and “substantially” used throughout the specification and appended claims are used to describe and account for small fluctuations or slight changes that do not materially affect the nature of the invention.

The method disclosed herein generally involves production of droplets using a microfluidic T-junction described in the review article by G F. Christopher and S. L. Anna (Supra), which is incorporated by reference in its entirety. In the technical field of microfluidic droplets manipulation, the term “T-junction” may generally refer to a microfluidic geometry that allows introduction of a dispersed phase fluid into a continuous phase fluid at an angle. The angle may generally range from 60 to 90 degrees, preferably from 80 to 90 degrees, and more preferably about 90 degrees. The term “continuous phase” as used herein may refer to a phase constituted by one material which is contiguous throughout the system, and mutually separated units of another heterogeneous material may be carried in the continuous phase. The term “dispersed phase” may refer to a phase constituted by mutually separated units of a material dispersed in the continuous phase, while each and every unit in the dispersed phase is surrounded by the continuous phase. A two-phase system composed of a continuous phase and a dispersed phase, commonly known as a disperse system. The “dispersed phase fluid” and “continuous phase fluid” are generally two immiscible fluids, which may result in forming droplets of the dispersed phase fluid in the continuous phase fluid at the joint of the T-junction geometry. As appreciated by those of ordinary skill in the art, the size of the droplets and the frequency of droplet generation are usually determined by the configuration of the flow channel, as well as the flow rates and properties of the fluids.

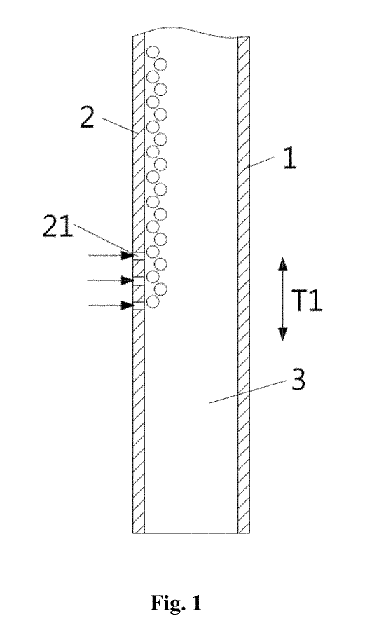

The method disclosed herein involves flowing a continuous phase fluid in the microfluidic passageway 3. According to the embodiment shown in FIG. 1, the microfluidic passageway 3 is defined by a first part 1 and a second part 2. The first part 1 is arranged opposite to the second part 2 and, preferably, the first part 1 is arranged substantially parallel to the second part 2, whereby the first and second parts 1, 2 are so spaced apart as to define the microfluidic passageway 3. The microfluidic passageway 3 extends in a longitudinal length direction T1, through which the continuous phase fluid may flow along the length direction T1. The microfluidic passageway 3 has a substantially constant cross section along the length direction T1, so that the fluid passing through the microfluidic passageway 3 does not substantially change its flow rate. The first and second parts 1, 2 may be independently made of the same or different rigid material. The term “rigid” as used herein may mean that no substantial deformation of the parts will occur during the practice of the invention. Examples of the rigid material suitable for use in the invention include, but are not limited to, metal (e.g., stainless steel), glass, quartz, ceramics, non-flexible plastics (e.g., acrylic plastics). Taking advantage of the rigid nature of the first part 1 and the second part 2, the microfluidic passageway 3 defined by the two parts is kept constant in size.

The processes for fabricating the first part 1 and the second part 2 are well known to those with ordinary skill in the art, and may be modified depending on the material used. For example, in the case where the first part 1 and the second part 2 are made of metallic material, they can be fabricated by conventional metal processing processes, such as stamping, rolling, lathe turning, stamping, forging, etc.

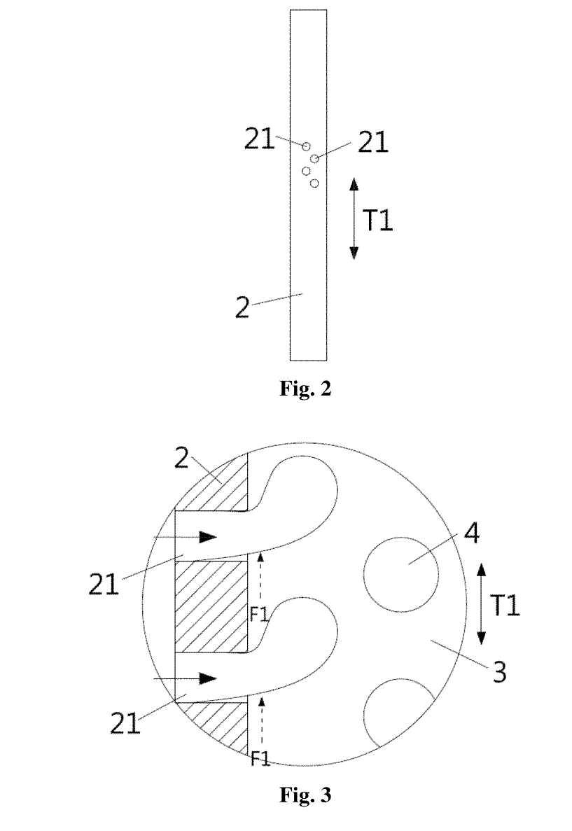

The apparatus disclosed herein is formed with a plurality of inlet orifices. Referring to the embodiments shown in the drawings, the second part 2 is formed with inlet orifices 21, through which the dispersed phase fluid is introduced into the microfluidic passageway 3 along the traverse direction to the length direction T1. The respective inlet orifices 21 are so arranged that the dispersed phase fluid can be introduced into the microfluidic passageway 3 at an angle ranging from 60 to 90 degrees, preferably from 80 to 90 degrees, and more preferably about 90 degrees, relative to the length direction T1. The inlet orifices 21 have a substantially uniform diameter. As shown in FIG. 2, the adjacent inlet orifices 21 are arranged to be offset from each other along the longitudinal length direction T1 and, preferably, the inlet orifices 21 are spaced apart from one another by substantially equal distances. Alternatively, the inlet orifices 21 may be formed on the first part 1.

As shown in FIG. 3, when the dispersed phase fluid is introduced into the microfluidic passageway 3 through the inlet orifices 21, the dispersed phase fluid is broken up by the shear stress F1 generated by the continuous phase fluid flowing in the microfluidic passageway 3. As a result, a plurality of droplets 4 of the dispersed phase fluid are formed in the continuous phase fluid within the microfluidic passageway 3. Since the cross-section of the microfluidic passageway 3 is substantially constant along the longitudinal length direction T1 and the volume ratio of the monodisperse droplets to the continuous phase fluid is relatively low, the flow rate of the continuous phase fluid flowing through the microfluidic passageway 3 approaches to a constant value. With the diameter of the inlet orifices 21 being substantially uniform, a large amount of monodisperse droplets 4 can be generated. The term “monodisperse” as used herein may indicate that the droplets 4 thus generated have a narrow size distribution, preferably having a polydispersity index of less than 8%. By virtue of the offsetting arrangement of the adjacent inlet orifices 21, the monodisperse droplets 4 formed by the adjacent inlet orifices 21 are offset with respect to each other in the longitudinal length direction T1, whereby they are prevented from interfering with or adhering to each other when flowing along the longitudinal length direction T1. The integrity of the monodisperse droplets can be maintained accordingly, thereby ensuring the quality of the monodisperse droplets.

In a preferred embodiment, the first part 1 is spaced apart from the second part 2 by a distance from 150 μm to 1 mm, so that the microfluidic passageway 3 has a width within a range of 150 μm to 1 mm. However, this range shall not be interpreted as the lower or upper limit of the width of the microfluidic passageway 3. In general, the diameter of the individual inlet orifices 21 is configured to be substantially smaller than the width of the microfluidic passageway 3.

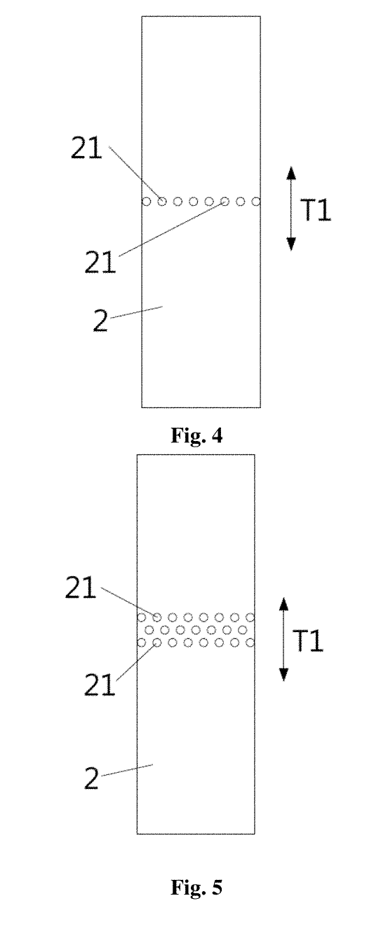

As shown in FIG. 2, the inlet orifices 21 may be arranged in zigzag along the longitudinal length direction T1, so that any adjacent two of the inlet orifices 21 are offset from each other in the longitudinal length direction T1. As shown in FIG. 4, the inlet orifice 21 may be arranged in a direction perpendicular to the longitudinal length direction T1. As shown in FIG. 5, the inlet orifices 21 may be arranged in several rows, with each row being perpendicular to the longitudinal length direction T1, and the inlet orifices 21 in the adjacent two rows are offset from each other in the longitudinal length direction T1, so that any adjacent two of the inlet orifices 21 is offset from each other in the length direction T1.

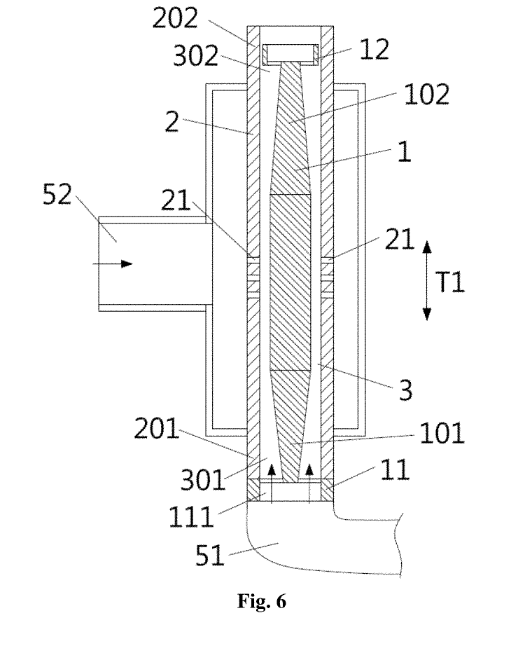

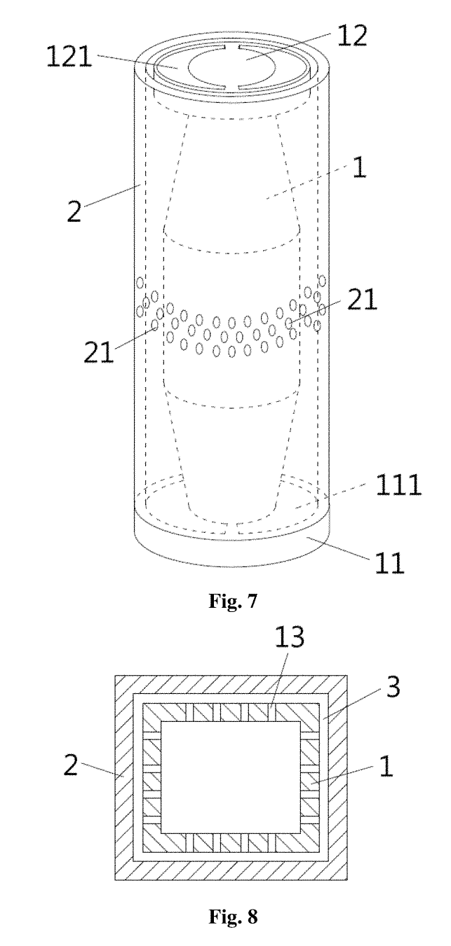

The first and second parts may be any structural elements capable of defining a microfluidic passageway 3 which has a substantially constant cross section along the length direction T1. In the preferred embodiments shown in FIG. 6 and FIG. 7, the first part 1 is configured as a hollow or solid rod, such as a hollow or solid cylindrical rod, extending along the length direction T1. The second part 2 is configured as a tubular housing and arranged concentrically with the first part 1, so that the first part 1 is sleeved within the second part 2 to define the microfluidic passageway 3 as an annular configuration. Compared to other configurations, the annular configuration is more suitable for being manufactured by precision machining. Since the width of the microfluidic passageway 3 is extremely small and constant, the continuous phase fluid travels in the microfluidic passageway 3 as if it is flowing between two parallel flat plates, so that high shear rate and high shear stress are generated in the vicinity of the surfaces of the first and second parts. The first part 1 has a first end 101 and a second end 102 opposite to the first end 101, whereas the second part 2 has a first end 201 and a second end 202 opposite to the first end 201. In order for the first part 1 being fixed in position relative to the second part 2, at least one anchoring member is provided between the first part 1 and the second part 2. In the embodiment shown in the FIG. 6, the first end 101 is provided with a first anchoring member 11 for securing the first part 1 to the second part 2. In one preferred embodiment, the first anchoring member 11 is configured as an enlarged portion of the first part 1 protruding beyond the second part 2 for holding an outer edge of the second part 2. The first anchoring member 11 is adapted to prevent the first part 1 from dislocation relative to the second part 2 in the longitudinal length direction T1 and in the radial direction with respect to the second part 2, so that the first part 1 will not dislocate relative to the second part 2 due to the dragging force generated by the flowing continuous phase fluid. In one preferred embodiment, the second end 102 is further provided with a second anchoring member 12 for securing the first part 1 to the second part 2, thereby preventing the first part from deviating radially with respect to the second part 2 to facilitate engagement with the second part 2 to maintain the concentric alignment. Preferably, the second anchoring member 12 is configured as an enlarged portion of the first part 1 adapted to be sleeved within the second part 2 for abutting against the second end 202 of the second part 2 radially.

As shown in FIGS. 6 and 7, the first anchoring member 11 is formed with an inlet 111 for the continuous phase fluid to enter the microfluidic passageway 3. In one preferred embodiment, the first end 101 of the first part 1 is gradually reduced in size, i.e., tapered, in the longitudinal length direction T1 toward the inlet 111, thereby defining a first connecting channel 301 together with the first end 201 of the second part 2. As shown in FIGS. 6 and 7, the first connecting channel 301 is connected to the inlet orifice 111 and the microfluidic passageway 3 in fluid communication manner. The first connecting channel 301 is gradually narrowed from the inlet 111 toward the microfluidic passageway 3, so that the continuous phase fluid passing through the inlet 111 can be stably accelerated in the first connecting channel 301 before reaching the microfluidic passageway 3. Similarly, the second anchoring member 12 is formed with an outlet 121 for the continuous phase fluid to exit the microfluidic passageway 3. In one preferred embodiment, the second end 102 of the first part 1 is gradually reduced in size, i.e., tapered, in the longitudinal length direction T1 toward the outlet 121, thereby defining a second connecting channel 302 together with the second end 202 of the second part 2. As shown, the second connecting channel 302 connects the outlet orifice 121 to the microfluidic passageway 3 in fluid communication manner. As a result, the second connecting channel 302 is gradually widened from the microfluidic passageway 3 toward the outlet 121, so that the continuous phase fluid passing through the microfluidic passageway 3 can be stably decelerated in the second connecting channel 302 and then exits through the outlet 121.

In addition, the apparatus may be further provided with a first feeding unit 51 as shown in FIG. 6, which fastened to the first anchoring member 11 and is in fluid communication with the inlet 111, thereby supplying the continuous phase fluid via the inlet 111. The first feeding unit 51 may be configured in any form that is suitable for replenishing the continuous phase fluid to the microfluidic passageway 3, which may include, but is not limited to, a reservoir tank, and is not particularly limited in structure or shape. Preferably, the feeding unit 51 is capable of keeping the continuous phase fluid from contamination and further adjusting the output pressure, flow rate and/or unit time output of the continuous phase fluid. In addition, the apparatus may be further provided with a second feeding unit 52, which is in fluid communication with the inlet orifices 21 for supplying the dispersed phase fluid. In a preferred embodiment, the second feeding unit 52 may be in any form that can supply the dispersed phase fluid in the form of a gas or a liquid, and deliver the gas or the liquid in the form of a gaseous stream or a liquid stream through the inlet orifices 21. The second feeding unit 52 may include, but is not limited to, reservoir tank, and is not particularly limited in structure or shape. Preferably, the second feeding unit 52 is capable of keeping the dispersed phase fluid from contamination and further adjusting the output pressure, flow rate and/or unit time output of the dispersed phase fluid.

In the first and second embodiments described above, the first part 1 is preferably configured as a hollow or solid cylindrical rod, and the second part 2 is preferably fabricated in the form of a circular tubular housing, while the inlet orifices 21 are formed on the second part 2. Alternatively, the first and second parts 1, 2 may be configured with a cross section in rectangular, hexagonal or other geometric shapes. According to the third embodiment shown in FIG. 8, the first and second parts 1, 2 are configured as two elongated tubes having a rectangular cross section, and the first part 1 is sleeved within the second part 2. As a result, the microfluidic passageway 3 defined by the first and second parts 1, 2 has a cross-section with a rectangular annular configuration, and the inlet orifices 13 are formed in the first part 1. In the third embodiment, the first part 1 is configured as a hollow cylindrical rod, so that the inlet orifices 13 can be in fluid communication with the second feeding unit 52 (not shown) to supply the dispersed phase fluid into the microfluidic passageway 3.

According to the review article by G. F. Christopher and S. L. Anna (Supra), the size of droplets can usually be determined by the following equation:

$$d \approx \frac{2 σ}{τ} = \frac{2 σ}{η \dot{ɛ}}$$

where d is the diameter of the droplet, 6 is the surface tension between the continuous phase fluid and the dispersed phase fluid, η is the viscosity of the continuous phase fluid, \dot{ε} is the shear rate of the continuous phase fluid near the inlet orifice, and τ is the shear stress of the continuous phase fluid near the inlet orifice. Thus, according to the invention, the diameter of the droplets 4 can be finely controlled by tuning the diameter of the inlet orifices 21, the width of the microfluidic passageway 3, the feeding pressure of the continuous phase fluid, the flow rate of the dispersed phase fluid, the viscosity of the dispersed phase fluid, the surface tension between the continuous phase fluid and the dispersed phase fluid and like parameters. A large quantity of droplets with a uniform size can be generated by the method and apparatus disclosed herein. By adjusting above-mentioned parameters, the diameter of the droplets can be adjusted to a specific size, which may be within a range of 50 microns to 1 millimeter, and the droplets have a polydispersity index of less than 8%.

In a preferred embodiment, the continuous phase fluid has a viscosity between 50 CP and 200 CP, the flow rate of the continuous phase fluid is between 100 ml/min and 500 ml/min, and the feeding pressure of the dispersed phase fluid is between 0.1 bar and 0.5 bar and, hence, monodisperse droplets with a uniform diameter between 100 μm and 500 μm may be produced.

The monodisperse droplets may contain a broad variety of ingredients, depending on the types of the continuous phase fluid and the dispersed phase fluid. For example, when the continuous phase fluid is a liquid while the dispersed phase fluid is a gas, the resultant monodisperse droplets are in the form of gaseous bubbles. In a preferred embodiment, the continuous phase fluid is an aqueous solution or an organic solution, while the dispersed phase fluid is air, nitrogen or a gaseous mixture. In another preferred embodiment, the continuous phase fluid and the dispersed phase fluid are two immiscible liquids, and the monodisperse droplets are in the form of an emulsion. In another preferred embodiment, the continuous phase fluid and the dispersed phase fluid may undergo physical or chemical reactions with each other, and the monodisperse droplets thus formed may have a core-shell architecture useful in the technical fields of pharmaceuticals and catalysts.

The monodisperse droplets formed according to the invention may be collected and utilized in various technical fields, such as the chemical and biochemical analysis mentioned above. During the collection, the monodisperse droplets may appear as spheres and self-assemble into a close-packing arrangement spontaneously. In the case where the monodisperse droplets are in the form of gaseous bubbles, a gelling reaction may proceed at the interface between the gaseous bubbles to fix the relative positions between the adjacent bubbles, forming a resilient three-dimensional scaffold. The walls of the bubbles may be perforated by allowing the bubbles to expand under low pressure, so that adjacent bubbles may be linked up to constitute a continuous space. The aggregate of monodisperse bubbles has a sponge-like or honeycomb-like architecture, and the interior thereof includes a large number of interconnected circular pores suitable for cells to adhere to and proliferate on. The three-dimensional scaffold has unique physical properties, such as light weight, low thermal conductivity and high porosity, and therefore it is adopted in many engineering and medical applications. One of the most notable applications is directed to the scaffold for cell culture use, which simulates an extracellular matrix for cells to grow. Cells may be inoculated into the scaffold and allowed to adhere to the scaffold, or the three-dimensional scaffold may by itself serve as a cell culture medium, so that cells may grow in the scaffold. Afterwards, the cells are given with growth factors and/or chemical stimuli so that they may proliferate, grow and differentiate in a simulated environment, thereby forming regenerative tissues or organs for transplantation into a patient to replace injured, dysfunctional or necrotic tissues and organs. Examples of natural materials which may be used in tissue scaffolds include gelatin, collagen, chitosan and sodium alginate. Artificial materials include polylactate (PLLA), polyglycolate (PGA), poly-lactic co-glycolic acid (PLGA) and so on. In addition to creating an excellent environment for cell growth, the tissue scaffold may also function to modulate the connection between cells and prevent cells from stacking.

It is worth noting that, according to the method and the apparatus disclosed herein, a large quantity of monodisperse droplets may be produced by introducing a dispersed phase fluid into a microfluidic passageway through a plurality of inlet orifices to meet a continuous phase fluid, which is a simple and fast approach for mass production. The continuous phase fluid and dispersed phase fluid used can be easily replaced depending on the needs, so that monodisperse droplets can be customized in terms of size and composition (e.g., in the form of bubbles or emulsions, or having a core-shell architecture). The droplets made according to the invention are substantially equal in size. Furthermore, the monodisperse droplets produced according to the invention may be employed to produce three-dimensional scaffolds useful in cell culture and tissue engineering. The invention disclosed herein enables a simple and large-scale production of monodisperse droplets with cost effectiveness.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

1. A method of generating substantially monodisperse droplets, comprising the steps of:
flowing a continuous phase fluid in a microfluidic passageway which extends in a longitudinal length direction, wherein the microfluidic passageway has a substantially constant cross section throughout its length; and
introducing a dispersed phase fluid into the microfluidic passageway along a traverse direction to the length direction through a plurality of inlet orifices to generate droplets of the dispersed phase fluid in the continuous phase fluid, wherein the plurality of inlet orifices have a substantially uniform diameter, and wherein any adjacent two of the plurality of inlet orifices are arranged offset from each other in the length direction.

2. The method according to claim 1, wherein the step of introducing the dispersed phase fluid along the traverse direction comprises introducing the dispersed phase fluid at an angle of about 90 degrees relative to the length direction.

3. An apparatus of generating substantially monodisperse droplets, comprising:
a substantially rigid first part; and
a substantially rigid second part arranged opposite to the first part to define a microfluidic passageway there-between through which a continuous phase fluid may flow, wherein the microfluidic passageway extends in a longitudinal length direction and has a substantially constant cross section throughout its length; and
wherein the apparatus is formed with a plurality of inlet orifices through which a dispersed phase fluid may be introduced into the microfluidic passageway along a traverse direction to the length direction to generate droplets of the dispersed phase fluid in the continuous phase fluid, and wherein the plurality of inlet orifices have a substantially uniform diameter, and wherein any adjacent two of the plurality of inlet orifices are arranged offset from each other in the length direction.

4. The apparatus according to claim 3, wherein the first part is configured in the form of a rod extending in the length direction, and the second part is configured in the form of an outer tubular housing concentrically disposed about the rod, thereby defining the microfluidic passageway in an annular configuration.

5. The apparatus according to claim 4, wherein the plurality of inlet orifices are formed on the second part.

6. The apparatus according to claim 4, wherein the plurality of inlet orifices are formed on the first part, and wherein the first part is configured in the form of a hollow rod.

7. The apparatus according to claim 4, wherein the first part includes a first end provided with a first anchoring part which is secured to a first end of the second part, thereby preventing the first part from dislocating relative to the second part.

8. The apparatus according to claim 7, wherein the first part includes a second end opposite to the first end of the first part, the second end of the first part being provided with a second anchoring part which radially abuts against a second end of the second part opposite to the first end of the second part, thereby preventing the first part from deviating radially with respect to the second part.

9. The apparatus according to claim 8, wherein the first anchoring part is formed with an inlet for the continuous phase fluid, and wherein the first end of the first part is tapered toward the inlet in the length direction, thereby defining with the first end of the second part a first connecting channel connecting in fluid communication the inlet to the microfluidic passageway.

10. The apparatus according to claim 9, wherein the second anchoring part is formed with an outlet, and wherein the second end of the first part is tapered toward the outlet in the length direction, thereby defining with the second end of the second part a second connecting channel connecting in fluid communication the outlet to the microfluidic passageway.

11. The apparatus according to claim 10, wherein the plurality of inlet orifices are arranged such that the dispersed phase fluid may be introduced into the microfluidic passageway at an angle of about 90 degrees relative to the length direction.
